(19) United States
(12) Patent Application Publication
(10) Pub. No.: US 2017/0220110 A1
(43) Pub. Date: Aug. 3, 2017

(54) Wearable Locomotion Capture Device

(71) Applicant: Peter Stanley Hollander, Doylestown, PA (US)

(72) Inventor: Peter Stanley Hollander, Doylestown, PA (US)

(21) Appl. No.: 15/422,884

(22) Filed: Feb. 2, 2017

Related U.S. Application Data
(60) Provisional application No. 62/290,451, filed on Feb. 3, 2016.

(51) Int. Cl. G06F 3/01; G06T 19/00; G06F 1/16; H04B 1/3827; G06F 3/00

(52) U.S. Cl. CPC G06F 3/014; H04B 1/385; G06F 3/002; G06F 3/011; G06F 1/163; G06T 19/006; H04L 67/12

(57) ABSTRACT

A wearable locomotion capture device, which in many cases may be used in generating virtual motion within a virtual environment. In certain embodiments, this is achieved by sensing changes in tactile pressure beneath the feet of a user. This pressure data can be interpreted by, for example, a virtual reality application wherein the application interprets the user to be walking in place in reality, and translates that static locomotive input into motion within the virtual world. This invention allows users to naturally and with great fidelity cover long distances in virtual reality without the need of large or restrictive hardware. In additional embodiments, auxiliary devices can be attached to this pressure sensing suite, supplementing the application with further user information, such as positional and rotational data, temperature, heartrate, along with other such forms of input.

This application claims priority to U.S. provisional patent application No. 62/290,451, filed on Feb. 2, 2016, the full disclosure of which is incorporated herein by reference.

### BACKGROUND

The embodiments described throughout this disclosure relate to the field of locomotion capture devices that have a variety of applications; many of which happen to fall into the field of virtual reality. Virtual reality has begun to emerge as a new fundamental medium of experiencing digital content largely due to its unmatched ability to immerse the user in an artificial environment. Within recent years, head mounted displays have become an integral element to experiencing virtual reality content, as well as the more recent introduction and standardization of hand-based user input. However, as these advancements have continued to develop, there remains a significant deficit in standardizing a means of allowing users to navigate these virtual worlds at larger scales.

Examples of frequently implemented solutions to this problem of navigation include one-to-one movement, teleportation, dashing motion, sliding motion, and climbing interaction within an experience. Other solutions being explored but not yet massively adopted include detecting walking motion through head-bobbing, arm-swinging, foot-stomping, or other means, sliding on low-friction platforms, and walking on omnidirectional treadmills. Each of these solutions currently suffers from some combination of the following issues/constraints: vection of the virtual world induces motion sickness; the movement is unnatural; the motion is discontinuous; the effective area is limiting; the sensing of input is contextually unreliable; the hardware is large; the hardware is restrictive; the hardware is financially inaccessible. Therefore, there is a need for a natural, unlimited, reliable, unrestrictive, compact, and financially accessible solution for locomotion capture devices which maintain continuity and user comfort that will provide users with a more satisfactory experience of virtual motion in a virtual environment.

Information relevant to the field of motion capture devices can be found in U.S. Patent Application Publications including, Lari et al., Pub. No. U.S. 2016/0038088, published Feb. 11, 2016; Kord, Pub. No. U.S. 2015/0358543, published Dec. 10, 2015; Connor, Pub. No. U.S. 2016/0338644, published Nov. 24, 2016; and U.S. patents including Bose et al., U.S. Pat. No. 9,247,212, issued Jan. 26, 2016; Carrell, U.S. Pat. No. 9,239,616, issued Jan. 19, 2016; and Vock et al., U.S. Pat. No. 7,171,331, issued Jan. 30, 2007. However, each one of these publications and patents suffer from one or more disadvantages, inclusive of those which are discussed above.

### BRIEF SUMMARY

Various features, aspects and advantages of the invention are better understood with regard to the following description, drawings and appended claims.

In one aspect of the invention, a wearable locomotion capture device, attached to the user's foot, comprises a sensor module that captures tactile pressure data of a user, the sensor module being in communication with a microprocessor module, which processes the tactile pressure data and is in communication with an output module configured to transceive data between the microprocessor module and a host processor configured to interpret the data captured from the user within the context of the user walking in place and wherein the interpreted data is used by a host application to generate virtual motion in a virtual environment. In this aspect of the invention, the device outlined in this disclosure overcomes all obstacles identified in the background, among others. The movement is natural, associating human stepping to locomotive motion, the effective area is unlimited, the data which can be supplied by pressure sensors is contextually reliable and can detect nuanced changes, the hardware is small and unrestrictive, and seeing as there are few required materials and no moving parts, the device should not be comparably expensive to manufacture. Continuity in motion and preventing motion sickness both must be achieved from within the host application (something that is entirely doable). As a result of this success, the device outlined in this aspect is capable of delivering a more satisfactory experience to users when it comes virtual motion in a virtual environment than any previously mentioned solution.

In another aspect of the invention, the output module is integrated with the microprocessor module as a single unit, or an auxiliary module, the output module and the microprocessor module are integrated as a single unit, which provides an even more compact design.

In yet another aspect of the invention, as a result of the small size of the device, it may be easily attached to an inanimate object which an individual wishes to track; for example and without limitation, a gun in virtual gaming or a camera in positional photography.

As apparent from the above aspects of the invention, advantages of the invention include, without limitation, a natural, unlimited, reliable, unrestrictive, compact, and financially accessible solution for locomotive navigation in virtual reality which maintains continuity and user comfort. The small size of the invention provides wearability such that a user can attach it to, for example and without limitation, feet or hands without the invention's presence being cumbersome. This ease of use provides a user with a more satisfactory experience in a virtual environment. The compact profile and wearability also provide improved mobility when compared to alternative solutions to capturing motion. One or more aspects of the disclosure provide for a wearable locomotion capture device that would find application in, without limitation, virtual reality. In addition to all of the above aspects of the invention, the compact size of the device provides wearability as a clothing accessory and adaptability to a wide population of users that desire a wide range of motion and a highly immersive experience in a virtual environment.

### BRIEF DESCRIPTION OF DRAWINGS

Additional features, aspects, and advantages of the invention in this disclosure are more apparent based on the description herein taken in conjunction with the following description of the accompanying drawings, which illustrate, by way of example, the principles of the invention, wherein:

FIG. 1 is a functional system diagram showing a user 101 with multiple positions illustrated for a sensor module 121, a microprocessor module 122, and an output module 123, as well as wired or wireless communication 140 between the output module 123 and a host processor 151, which has a host application 155, according to one embodiment of the invention;

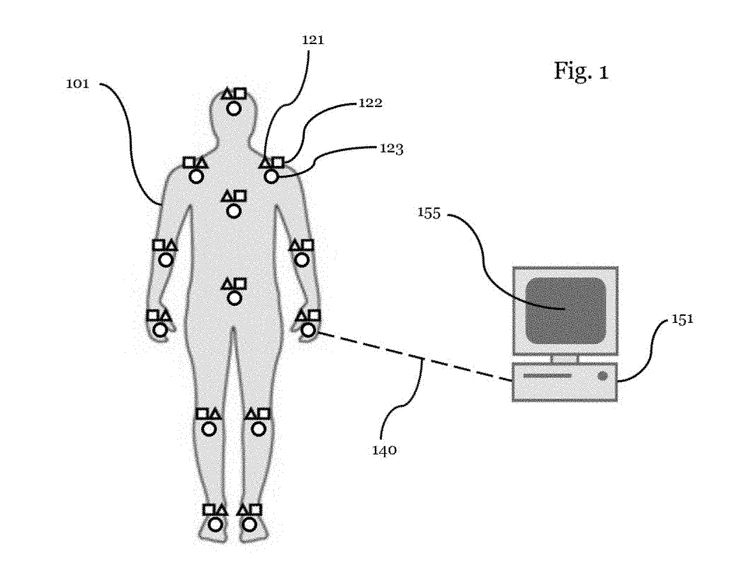

FIG. 2 is a system block diagram showing physical user data captured by a sensor module in communication with a microprocessor module, which is in communication with an output module that has external communications with a host processor having a host application, and showing physical user data captured by an optional auxiliary module with input to the microprocessor module and output to the auxiliary module, and communicated back to the user as feedback, according to one embodiment of the invention;

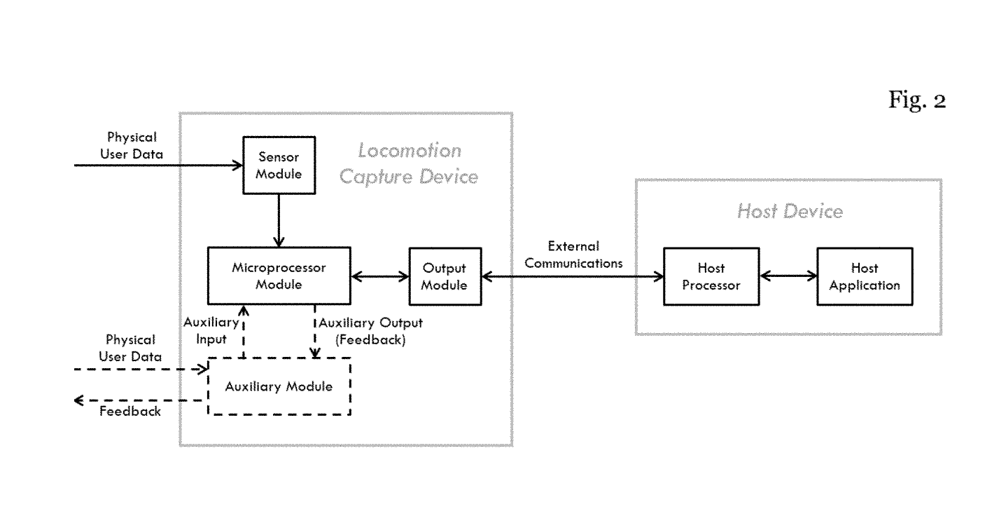

FIG. 3 is a sensor module block diagram showing a user in communication with a sensor module comprising one or more of a pressure sensor, inertial sensor, auxiliary sensor, optical sensor, optical emitter, and a feedback device, which are in communication with a microprocessor module, according to one embodiment of the invention;

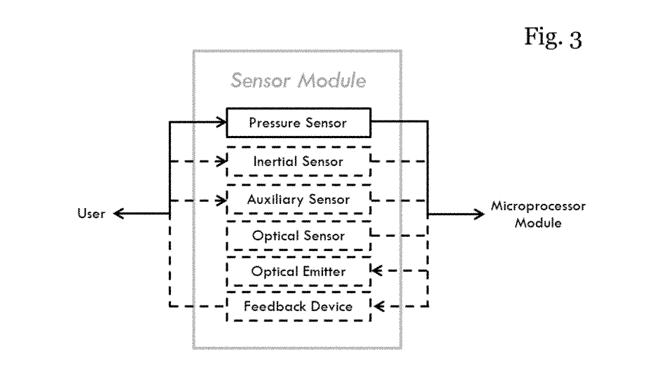

FIG. 4 is an example showing the foot 402 of a user 101 with a universal foot strap 410 and a pressure sensor 420 that is connected by an electrical connection 423 to an electrical connector 427, according to one embodiment of the invention;

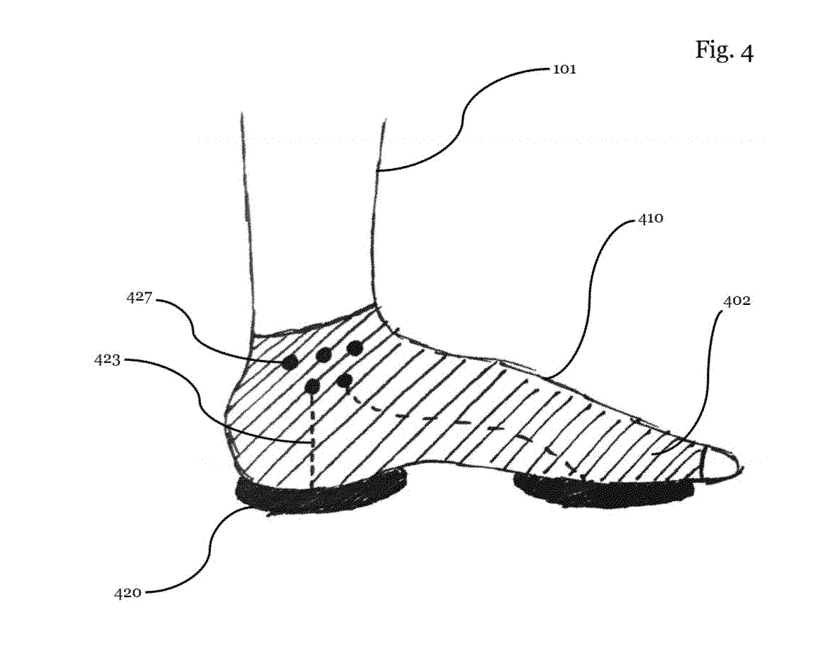

FIG. 5 is an example showing the foot 402 of a user 101 with a universal foot strap 410 and a pressure sensor 420 that is connected by an electrical connection 423 to an electrical connector 427, as well as a microprocessor module 540 and an output module 550 that are integrated as a single unit, according to one embodiment of the invention;

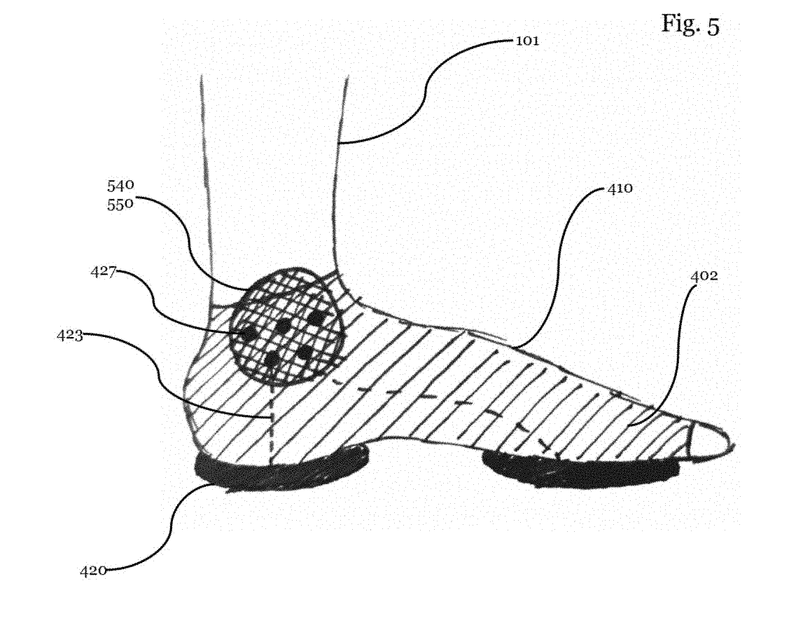

FIG. 6 is an example showing the hand 603 of a user 101 with a universal hand strap 611 and a pressure sensor 420 that is connected by an electrical connection 423 to an electrical connector 427, as well as a microprocessor module 540 and an output module 550 that are integrated as a single unit, according to one embodiment of the invention.

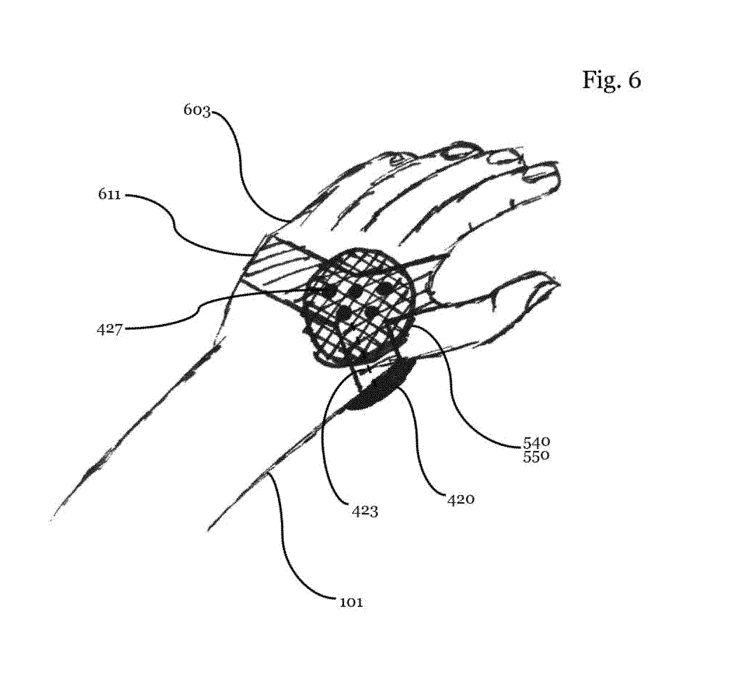

### DESCRIPTION

In the brief summary above and in the description of the invention, and the appended claims, and in the drawings, an embodiment of the invention may reference to particular features of the invention, which features may be used, to the extent possible, in combination with or in the context of other embodiments of the invention, and in the invention generally. As used in this disclosure including the claims, the terms “a” or “an” are defined broadly to mean one or more.

The term locomotion capture is meant to be broadly understood to encompass not only capturing motion data, for example and without limitation, natural movements of a user such as walking in place, but also capture other physical data of its user, for example and without limitation, capturing changes to weight distributions beneath a user's feet. The term wearable is broadly defined to include, for example and without limitation, the ability to attach the locomotion capture device to some physical part of a user. The term user is defined as an either animate or inanimate unit, so as to include, for example and without limitation, an animate being such as a human or an inanimate object such as a camera. Thus, in one embodiment of the invention, the device is attached to a part of an animate human body and captures physical data from that body part. In another embodiment of the invention, the device is attached to an inanimate object and captures physical data from that object. The physical data of a user includes, for example and without limitation, tactile pressure data and the sensing of subtle changes to weight and pressure distributions. The term auxiliary sensor includes, for example and without limitation, inertial sensors such as, for example and without limitation, an accelerometer, a magnetometer, and a gyroscope. The term auxiliary sensor may also include, for example and without limitation, heart rate sensor, temperature sensor or ultrasonic sensor. The term auxiliary sensor may also include, for example and without limitation, an optical unit that either senses or outputs optical signals. The term feedback device is defined broadly to include being integrated with or part of the sensor module or the microprocessor module or as a separate module of its own. The feedback device is akin to an auxiliary output device. The term auxiliary module is defined broadly as a module containing at least one of an auxiliary sensor or a feedback device. The term power source is defined broadly to include being integrated with the microprocessor module, or sourced from the host processor, or sourced from an external power supply, such as, for example and without limitation, a portable battery or an electrical outlet. The term host processor is defined broadly to include, for example and without limitation, the hardware that receives data from the microprocessor module, for example and without limitation, a computer, game console, mobile device, or other device capable of such functionality.

In an embodiment of the invention, a wearable locomotion capture device, attached to a user's foot, comprises a sensor module that captures tactile pressure data of a user in communication with a microprocessor module with an integrated power source, which processes the tactile pressure data and is in communication with an output module configured to transceive data between the microprocessor module and a host processor configured to interpret the data captured from the user within the context of the user walking in place and wherein the interpreted data is used by a host application to generate virtual motion in a virtual environment.

In another embodiment of the invention, the output module and the microprocessor module are integrated as a single unit and are in communication with the sensor module and wherein the output module transceives data between the microprocessor module and a host processor wherein the microprocessor module is the power source for the device.

In yet another embodiment of the invention, the auxiliary module, output module and the microprocessor module are integrated as a single unit and are in communication with the sensor module and wherein the output module transceives data between the microprocessor module and a host processor wherein the microprocessor module is the power source for the device.

In yet another embodiment of the invention, the output module and the microprocessor module are integrated as a single unit and are in communication with the sensor module and wherein the output module transceives data between the microprocessor module and a host processor wherein the host processor is the power source for the device.

In yet another embodiment of the invention, the auxiliary module, output module and the microprocessor module are integrated as a single unit and are in communication with the sensor module and wherein the output module transceives data between the microprocessor module and a host processor wherein the host processor is the power source for the device.

In yet another embodiment of the invention, the output module, the microprocessor module, and the sensor module are integrated as a single unit wherein the output module transceives data between the microprocessor module and a host processor wherein the microprocessor module is the power source for the device.

In yet another embodiment of the invention, the output module, the microprocessor module, and the sensor module are integrated as a single unit wherein the output module transceives data between the microprocessor module and a host processor wherein the host processor is the power source for the device.

The captured data can be used for many applications, including but not limited to, virtual reality locomotion, including long-distance virtual navigation, immersive gaming, physical therapy or rehabilitation, accessibility to alternative device interfacing, fitness tracking, and simulation training. Although the invention is described herein in considerable detail and with reference to various embodiments thereof, other embodiments and versions are possible. Therefore, the scope of the appended claims should not be limited to the description of any embodiment contained herein.

What is claimed is:

1. A wearable locomotion capture device comprising:
a sensor module configured to capture physical data of a user;
a microprocessor module in communication with the sensor module and configured to process data from the sensor module;
a power source; and
an output module in communication with the microprocessor module and configured to transceive data between the microprocessor and a host processor.

2. The wearable locomotion capture device of claim 1 wherein the sensor module comprises at least one of a pressure sensor and an auxiliary sensor.

3. The wearable locomotion capture device of claim 2 wherein the auxiliary sensor comprises at least one of an inertial sensor and an optical unit.

4. The wearable locomotion capture device of claim 1 further comprising an auxiliary module in communication with the microprocessor module.

5. The wearable locomotion capture device of claim 1 further comprising an auxiliary module, wherein the auxiliary module, the output module and the microprocessor module are integrated as a single unit and in communication with the sensor module.

6. The wearable locomotion capture device of claim 1 wherein the output module and the microprocessor module are integrated as a single unit and in communication with the sensor module.

7. The wearable locomotion capture device of claim 1 further comprising a feedback device in communication with the microprocessor module and the user.

8. The wearable locomotion capture device of claim 1 wherein data transmission between the output module and the host processor comprises a wired or wireless connection.

9. The wearable locomotion capture device of claim 1 wherein the device is attached to a user's foot.

10. The wearable locomotion capture device of claim 9 wherein the data is interpreted within the context of the user walking in place.

11. The wearable locomotion capture device of claim 10 further comprising the host processor having a host application that processes data sent by the output module and wherein the interpreted data is used by the host application to generate virtual motion in a virtual environment.

12. The wearable locomotion capture device of claim 1 wherein the device is attached to a user's hand.

13. The wearable locomotion capture device of claim 1 wherein the sensor module is configured to capture tactile pressure data of a user.

14. The wearable locomotion capture device of claim 1 wherein the power source is located in the microprocessor module.

15. The wearable locomotion capture device of claim 1 wherein the power source is provided from the host processor.

16. The wearable locomotion capture device of claim 1 wherein the host processor comprises a computer, a game console, a mobile device, or processor unit other than the microprocessor module of the wearable locomotion capture device.

17. The wearable locomotion capture device of claim 1 further comprising the host processor having a host application that processes data sent by the output module.

18. The wearable locomotion capture device of claim 1 wherein the host processor is further configured to receive additional motion, positional, rotational, or other physical input data from sources other than the wearable locomotion device.

19. A wearable locomotion capture device comprising:
a sensor module configured to capture tactile pressure data of a user;
a microprocessor module in communication with the sensor module and configured to process tactile pressure data from the sensor module;
a power source; and
wherein the sensor module and the microprocessor module are attached to the user's foot; and
an output module in communication with the microprocessor module and configured to transceive data between the microprocessor module and a host processor configured to interpret the data captured from the user within the context of the user walking in place and wherein the interpreted data is used by a host application to generate virtual motion in a virtual environment.

20. A locomotion capture device comprising:
a sensor module configured to capture physical data of an object;
a microprocessor module in communication with the sensor module and configured to process data from the sensor module;
a power source; and
an output module in communication with the microprocessor module and configured to transceive data between the microprocessor module and a host processor.
